(19) United States
(12) Patent Application Publication
(10) Pub. No.: US 2023/0019213 A1
(43) Pub. Date: Jan. 19, 2023

(54) BANDWIDTH SIGNALING FOR CONTROL FRAMES

(71) Applicant: MAXLINEAR, INC., Carlsbad, CA (US)

(72) Inventors: Sigurd Schelstraete, Menlo Park, CA (US); Oren Kedem, Modii'n-Maccabim-Reut (IL)

(21) Appl. No.: 17/811,858

(22) Filed: Jul. 11, 2022

Related U.S. Application Data
(60) Provisional application No. 63/203,189, filed on Jul. 12, 2021.

(51) Int. Cl. H04W 74/08; H04L 1/00; H04W 74/00

(52) U.S. Cl. CPC H04W 74/0816; H04L 1/0068; H04W 74/0866; H04W 74/002

(57) ABSTRACT

A system for wireless communication includes data processing hardware, and memory hardware in communication with the data processing hardware. The memory hardware stores instructions that when executed on the data processing hardware cause the data processing hardware to perform operations. The operations include generating a control frame including a frame control field. The operations also include transmitting the control frame including indicating data in the frame control field. The indicating data indicates that the control frame includes bandwidth information.

### CROSS REFERENCE TO RELATED APPLICATIONS

This U.S. patent application claims priority to U.S. Provisional Patent Application 63/203,189 filed on Jul. 12, 2021. The disclosure of this prior application is considered part of the disclosure of this application and is hereby incorporated by reference in its entirety.

### TECHNICAL FIELD

This disclosure relates to a system for wireless communication (e.g., communication using Wi-Fi protocols).

### BACKGROUND

Institute of Electrical and Electronics Engineers (IEEE) 802.11 wireless networking standards have evolved to meet user demands for faster and more robust communication. One of the methods implemented to the standards to meet the demands is expending the bandwidth (capacity) for the wireless network. Accordingly, few methods have been implemented to the standards to manage expending bandwidth efficiently.

The subject matter claimed in the present disclosure is not limited to implementations that solve any disadvantages or that operate only in environments such as those described above. Rather, this background is only provided to illustrate one example technology area where some embodiments described in the present disclosure may be practiced.

### SUMMARY

One aspect of the disclosure provides a system for wireless communication. The system includes data processing hardware and memory hardware in communication with the data processing hardware. The memory hardware stores instructions that when executed on the data processing hardware cause the data processing hardware to perform operations. The operations include generating a control frame. The control frame includes a frame control field. The operations also include transmitting the control frame including indicating data in the frame control field. The indicating data indicates that the control frame includes a bandwidth information.

Implementations of the disclosure may include one or more of the following optional features. In some implementations, the bandwidth information includes color data (e.g., basic service set (BSS) color data). In some implementations, the bandwidth information includes transmission opportunity data. In some implementations, the bandwidth information includes preamble puncturing data. In some implementations the preamble puncturing data includes dynamic preamble puncturing data. In some implementations, the bandwidth information includes data that support dynamic request to send (RTS)/clear to send (CTS) negotiation. In some implementations, the bandwidth information includes bandwidth information for any bandwidth value including 320 MHz or greater than 320 MHz. In some implementations, the bandwidth information is included in the control frame instead of a high throughput control field. In some implementations, the control frame is in a non-high throughput duplicate format. In some implementations, the bandwidth information in provided in a bandwidth information field.

Another aspect of the disclosure provides a system for wireless communication. The system includes data processing hardware and memory hardware in communication with the data processing hardware. The memory hardware stores instructions that when executed on the data processing hardware cause the data processing hardware to perform operations. The operations include obtaining a control frame. The operations also include determining that the control frame includes indicating data in a frame control field. The indicating data is configured to indicate that the control frame includes a bandwidth information. The operations include processing the bandwidth information, when the indicating data is determined to be in the frame control field.

Implementations of the disclosure may include one or more of the following optional features. In some implementations, the indicating data is provided in a subtype sub-field of the frame control field. In some implementations, the bandwidth information includes color data (e.g., basic service set (BSS) color data). In some implementations, the bandwidth information includes transmission opportunity data. In some implementations, the bandwidth information includes preamble puncturing data. In some implementations, the preamble puncturing data includes dynamic preamble puncturing data. In some implementations, the bandwidth information includes data that support dynamic request to send (RTS)/clear to send (CTS) negotiation. In some implementations, the bandwidth information includes bandwidth information for any bandwidth value including 320 MHz or greater than 320 MHz.

Another aspect of the disclosure provides a system for wireless communication. The system includes data processing hardware and memory hardware in communication with the data processing hardware. The memory hardware stores instructions that when executed on the data processing hardware cause the data processing hardware to perform operations. The operations include generating a control frame. The control frame includes a high throughput control field. The operations also include transmitting the control frame including indicating data in the high throughput control field. The indicating data may provide that the high throughput control field includes bandwidth information. The indicating data may provide that the control frame includes bandwidth information.

Implementations of the disclosure may include one or more of the following optional features. In some implementations, the bandwidth information includes at least one from color data (e.g., basic service set (BSS) color data), preamble puncturing data, transmission opportunity data, and data that supports send (RTS)/clear to send (CTS) negotiation. In some implementations, the preamble puncturing data includes dynamic preamble puncturing data. In some implementations, the bandwidth information includes bandwidth information for any bandwidth value including 320 MHz or greater than 320 MHz. In some implementations, the control frame is in a non-high throughput duplicate format. In some implementations, the control frame is a control wrapper frame.

### DESCRIPTION OF DRAWINGS

Example implementations will be described and explained with additional specificity and detail through the use of the accompanying drawings in which:

FIG. 1 is a simplified schematic view of a first station and a second station communicating an example control frame in accordance with some implementations of the present disclosure;

FIG. 2 is a simplified schematic view of a third station and a fourth station communicating another example control frame in accordance with some implementations of the present disclosure;

FIG. 3 is a flowchart of an example arrangement of operations for a method of communicating a control frame with a bandwidth information field in accordance with some implementations of the present disclosure;

FIG. 4 is a flowchart of another example arrangement of operations for a method of communicating a control frame with a high throughput control field in accordance with some implementations of the present disclosure; and

FIG. 5 is a schematic view illustrating a machine in the example form of a computing device.

Like reference symbols in the various drawings indicate like elements.

### DETAILED DESCRIPTION

IEEE 802.11ac, a wireless networking standard, introduced bandwidth signaling for control frames that may be sent in non-high throughput (HT) duplicate format. The bandwidth signaling may provide explicit bandwidth information that cannot be carried natively in non-HT duplicate. For example, it may not be carried in an occupied bandwidth, or in support of dynamic bandwidth request to send (RTS)/clear to send (CTS) negotiation.

The bandwidth signaling may be un-conventional, such as with legacy devices. For example, some bits of a scrambler seed may be repurposed. Alternatively or additionally, the presence of bandwidth signaling may be indicated with an individual and/or group bit of a transmitter address (TA) (e.g., a bandwidth signaling TA). Additionally, the bandwidth signaling may not be adequate for a bandwidth that is greater than 160 MHz.

IEEE 802.11be, a newer wireless network standard, added support for an extra-wide 320 MHz bandwidth channel. For example, the single channel bandwidth is proposed to be increased from 160 MHz to 320 MHz with six channels (with possible overlap) in the 6 GHz. However, the bandwidth signaling discussed above for IEEE 802.11ac may not be able to provide explicit bandwidth information for the extra-wide bandwidth (e.g., bandwidth greater than 160 MHz).

The present disclosure provides various methods of communicating the bandwidth information in non-HT duplicate that may be more efficient for the extra-wide bandwidth. In some implementations, the non-HT duplicate format may be preferred for transmitting control frames since the non-HT duplicate format acts as a common denominator for any generation of Wi-Fi. Alternatively or additionally, duplication may make information available to all device, which may include a partially overlapping basic service set (OBSS) or an OBSS with different primaries.

The present disclosure includes implementations of methods of communicating bandwidth information in a control frame that may be compatible with legacy devices. In some implementations, a new control frame subtype (e.g., bandwidth signaling control wrapper) which may be similar to a control wrapper frame is used to carry the bandwidth information. In some implementations, the bandwidth signaling control wrapper frame includes bandwidth information field in lieu of high throughput (HT) control frame, which may be present with the control wrapper frame. The bandwidth signaling control wrapper frame includes the bandwidth information field that is suitable to include the bandwidth information (e.g., bandwidth information of 320 MHz bandwidth). In some implementations, a conventional control wrapper frame is used to carry the bandwidth information. To store the bandwidth information, the HT control frame of the control wrapper frame may be re-configured to include the bandwidth information.

In some implementations, the bandwidth information includes color data (e.g., basic service set (BSS) color data). In some implementations, the bandwidth information includes preamble puncturing data. In some implementations, the preamble puncturing data includes dynamic preamble puncturing data (e.g., preamble puncturing data that is decided on a per-packet basis, rather than a common puncturing data applied to all packets sent in the basic service set (BSS)). In some implementations, the bandwidth information includes data that support dynamic request to send (RTS)/clear to send (CTS) negotiation. In some implementations, the bandwidth information includes bandwidth information related to a bandwidth (e.g, first bandwidth of 320 MHz, second bandwidth that is greater than 320 MHz, third bandwidth that is less than 320 MHz, any combination of the first bandwidth, second bandwidth, and third bandwidth).

The advantage of methods disclosed in the present disclosure is that the methods are compatible with the non-HT format and compatible with legacy devices. In other words, the methods are backwards compatible.

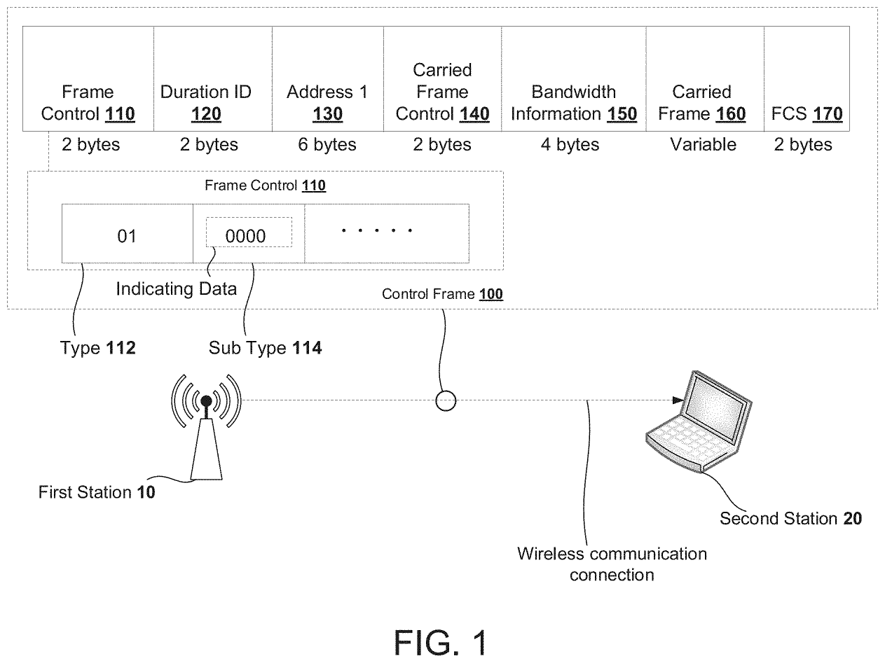

FIG. 1 is a simplified schematic view of a first station 10 (access point in this example) and a second station 20 (mobile computing device in this example) communicating (e.g., transmitting and receiving) an example control frame 100 (in non-HT duplicate format) including a bandwidth information field 150 that is capable of including bandwidth information (e.g., bandwidth signaling for 320 MHz bandwidth) in accordance with some implementations of the present disclosure. In this example, a station (e.g., first station 10, second station 20) is a device or system (e.g., computing device with data processing hardware and memory hardware) that has the capability to use the IEEE 802.11 protocols.

As illustrated in FIG. 1, in some implementations, the first station 10 is configured to generate and transmit the control frame 100 including various fields: a frame control field 110, a duration ID field 120, an address 1 field 130, a carried frame control field 140, the bandwidth information field 150, a carried frame field 160, and a frame check sequence (FCS) field 170.

As shown, in some implementations, the frame control field 110 includes various sub-fields including a type sub-field 112 (including “01” value which indicates that the frame 100 is a control frame as shown in the FIG. 1) and a subtype sub-field 114. As shown in TABLE 1 below, based on pre-assigned values (e.g., binary values) in the subtype sub-field 114, the subtype of the control frame 100 is determined.

TABLE 1

| Subtype Value | Subtype |
|---|---|
| 0111 | Control wrapper frame |
| 1000 | Block ack request (BlockAckReq) frame |
| 1001 | Block ack (BlockAck) frame |
| 1010 | Power save polling (PS-Poll) frame |
| 1011 | Request to send (RTS) frame |
| 1100 | Clear to send (CTS) frame |
| 1101 | Acknowledgement (ACK) frame |
| 1110 | Contention free-end(CF-End) frame |
| 1111 | Contention free-end (CF-End) and |
| | contention free-acknowledgement (CF- |
| | Ack) frame |
| 0000 | Bandwidth signaling control wrapper |
| | frame |
| 0000-0110 (0001-0110 | Reserved |
| when 0000 is used to | |
| indicate the subtype) | |

As shown in TABLE 1 above, different values are pre-assigned for different control frame subtypes: “0111” for control wrapper frame, “1000” for block ack request (BlockAckReq) frame, “1001” for block ack (BlockAck) frame, “1010” for PS-Poll frame, “1011” for RTS frame, “1100” for CTS frame, “1101” for ACK frame, “1110” for CF-End frame, and “1111” for CF-END and CF-Ack frame.

As shown in TABLE 1 and FIG. 1, in some implementations, a reserved value “0000” may be defined as a newly assigned value for a new control frame subtype: bandwidth signaling control wrapper frame. As a result, the control frame 100 in FIG. 1 is a bandwidth signaling control wrapper frame. In some implementations, other reserved value from “0000” to “0110” or any suitable value can be defined or pre-assigned as the newly assigned value to indicate that the control frame 100 is a bandwidth signaling control wrapper frame.

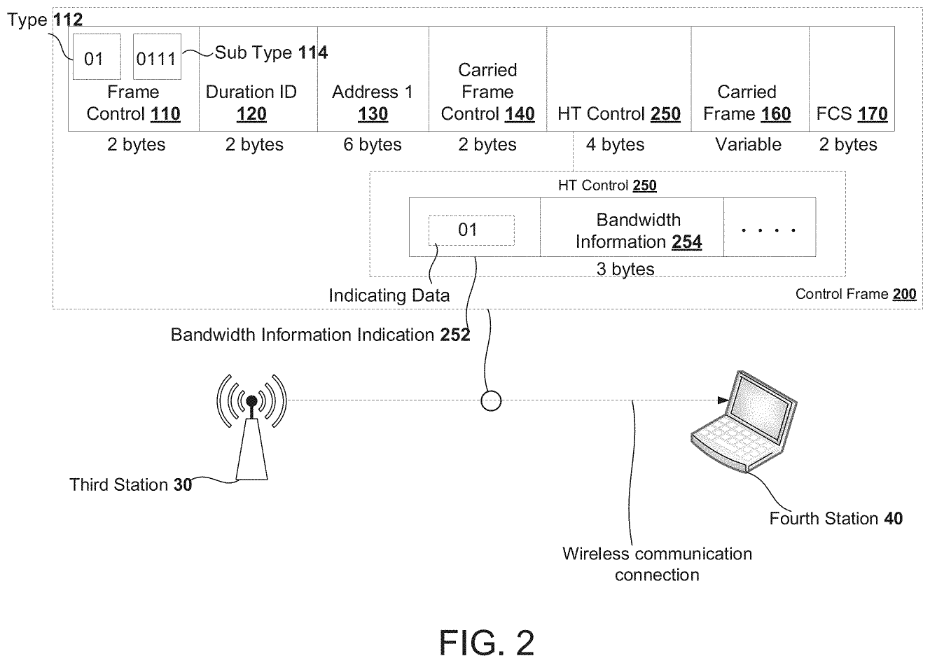

In some implementations, the newly assigned value (also referred as “first indicating data” in this disclosure) (“0000” in this example) in the subtype sub-field 114 indicates that the control frame 100 is a bandwidth signaling control wrapper frame that includes the bandwidth information field 150 instead of, or in addition to, a high throughput (HT) control field 250 (shown in FIG. 2). In other words, the first indicating data in the subtype sub-field 114 indicates that the control frame 100 includes the bandwidth information field 150 that is configured to include or store bandwidth information. Accordingly, the first indicating data in the subtype sub-field 114 indicates that the control frame 100 includes the bandwidth information.

In some implementations, the bandwidth information field 150 includes the bandwidth information. As shown in FIG. 1, the bandwidth information field 150 is capable of storing 4 bytes of information (e.g., 4 bytes of bandwidth information for 320 MHz bandwidth). However, the present disclosure does not limit the size of the bandwidth information field 150. In some implementations, the bandwidth information field 150 is configured to store or include less than 4 byes of bandwidth information (e.g., one byte, two bytes). In some implementations, the bandwidth information field 150 is configured to store or include more than 4 byes of bandwidth information (e.g., five bytes, six bytes). In some implementations, the size of the bandwidth information field 150 increases as the bandwidth (of channel) increases. In some implementations, the size of the bandwidth information field 150 decreases as the bandwidth (of channel) decreases.

In some implementations, the bandwidth information field 150 includes bandwidth information related to a bandwidth (e.g., first bandwidth of 320 MHz, second bandwidth that is greater than 320 MHz, third bandwidth that is less than 320 MHz, any combination of the first bandwidth, second bandwidth, and third bandwidth). In some implementations, the bandwidth information includes additional information (e.g., non-bandwidth related information). In some implementations, the bandwidth information includes color data (e.g., basic service set (BSS) color data). In some implementations, the bandwidth information includes bandwidth occupation data (e.g., data indicates what portion of the bandwidth is being occupied by other communication and/or noise). In some implementations, the bandwidth information includes preamble puncturing data. In some implementations, the preamble puncturing data includes dynamic preamble puncturing data. In some implementations, the bandwidth information includes data related to (dynamic) request to send (RTS)/clear to send (CTS) negotiation. In some implementations, the bandwidth information includes transmission opportunity (TXOP) information.

As illustrated in FIG. 1, in some implementations, the second station 20 is configured to receive or obtain the control frame 100 from the first station 100. As discussed, the control frame 100 includes various fields: the frame control field 110, the duration ID field 120, the address 1 field 130, the carried frame control field 140, the bandwidth information field 150, the carried frame field 160, and the frame check sequence (FCS) field 170.

In some implementations, the second station 20 is configured to determine that whether the control frame 100 includes the first indicating data (“0000” in FIG. 1 in this example) in (the subtype sub-field 114 of) the frame control field 110.

In some implementation, the second station 20 is configured to determine that the control frame 100 is a bandwidth signaling control wrapper frame (including the bandwidth information 150 field) based on the first indicating data in the frame control field 110. In some implementations, the second station 20 is configured to determine that the control frame 100 includes the bandwidth information field 150 based on the first indicating data in the frame control field 110. In some implementations, the second station 20 is configured to determine that the control frame 100 includes the bandwidth information based on the first indicating data in the frame control field 110.

In some implementations, the second station 20 is configured to process the bandwidth information in response to determining that the control frame 100 includes the bandwidth information. In some implementations, the second station 20 is configured to process the bandwidth information (in the bandwidth information field 150) in response to determining that the control frame 100 is the bandwidth signaling control wrapper frame and/or the control frame 100 includes the bandwidth information field 150. In some implementations, the processed information is used to communicate with the first station 10 efficiently.

As discussed above, the bandwidth information field 150 is capable of including various types of information.

FIG. 2 is a simplified schematic view of a third station 30 (access point in this example) and a fourth station 40 (mobile computing device in this example) communicating (e.g., transmitting and receiving) another example control frame 200 (in non-HT duplicate format) including a HT control field 250 that is capable of including bandwidth information (e.g., bandwidth signaling for 320 MHz bandwidth) in accordance with some implementations of the present disclosure. In this example, a station (e.g., third station 30, fourth station 40) is a device or system (e.g., computing device with data processing hardware and memory hardware) that has the capability to use the IEEE 802.11 protocols.

As illustrated in FIG. 2, in some implementations, the third station 30 is configured to generate and transmit the control frame 200 including various fields: a frame control field 110, a duration ID field 120, an address 1 field 130, a carried frame control field 140, the HT control filed 250, a carried frame field 160, and a frame check sequence (FCS) field 170.

As shown in FIG. 2, the type sub-field 112 of the frame control field 110 includes “01,” and the subtype sub-field 114 of the frame control field 110 includes “0111.” As a result, the control frame 200 is a control wrapper frame.

As shown in FIG. 2, in some implementations, the HT control field 250 includes various sub-fields including a bandwidth information indication sub-field 252 and bandwidth information sub-field 254. In some implementations, the bandwidth information indication sub-field 252 is capable of including a second indicating data which indicates that the control frame 200 includes the bandwidth information. In some implementations, the second indicating data indicates that the HT control field 250 includes a bandwidth information sub-field 254 (capable of including bandwidth information). For example, as shown in FIG. 2, a value “01” in the bandwidth information indication sub-field 252 can be pre-assigned to be the second indicating data which indicates that the HT control field 250 includes the bandwidth information sub-field 254. In some implementations, the second indicating data indicates that the control frame 200 includes bandwidth information. However, present disclosure does not limit that the second indicating data to be “01.” In some implementations, the second indicating data can be any suitable value.

In some implementations, the bandwidth information sub-field 254 includes bandwidth information. As shown in FIG. 2, the bandwidth information sub-field 254 is capable of storing 3 bytes of information (e.g., 3 bytes of bandwidth information for 320 MHz bandwidth). However, the present disclosure does not limit the size of the bandwidth information sub-field 254. In some implementations, the bandwidth information sub-field 254 is configured to store or include less than 3 byes of bandwidth information (e.g., one byte, two bytes). In some implementations, the bandwidth information sub-field 254 is configured to store or include more than 3 byes of bandwidth information. In some implementations, the size of the bandwidth information sub-field 254 increases as the bandwidth (of channel) increases. In some implementations, the size of the bandwidth information sub-field 254 decreases as the bandwidth (of channel) decreases. However, the present disclosure does not limit the location of the bandwidth information. In some implementations, the bandwidth information is provided at any suitable location (e.g., field, sub-field) within the control frame 200.

In some implementations, the bandwidth information sub-field 254 (and/or the suitable location within the control frame 200) includes bandwidth information related to a bandwidth (e.g., first bandwidth of 320 MHz, second bandwidth that is greater than 320 MHz, third bandwidth that is less than 320 MHz, any combination of the first bandwidth, second bandwidth, and third bandwidth). In some implementations, the bandwidth information includes additional information (e.g., non-bandwidth related information). In some implementations, the bandwidth information includes color data (e.g., basic service set (BSS) color data). In some implementations, the bandwidth information includes bandwidth occupation data (e.g., data indicates what portion of the bandwidth being occupied by other communication and/or noise). In some implementations, the bandwidth information field includes preamble puncturing data. In some implementations, the preamble puncturing data includes dynamic preamble puncturing data. In some implementations, the bandwidth information includes data related to (dynamic) request to send (RTS)/clear to send (CTS) negotiation. In some implementations, the bandwidth information includes transmission opportunity (TXOP) information.

As illustrated in FIG. 2, in some implementations, the fourth station 40 is configured to receive or obtain the control frame 200 (control wrapper frame as shown in FIG. 2) from the third station 30. As discussed, the control frame 200 includes various fields: the frame control field 110, the duration ID field 120, the address 1 field 130, the carried frame control field 140, the HT control 250, the carried frame field 160, and the frame check sequence (FCS) field 170.

In some implementations, the fourth station 40 is configured to determine that whether the HT control field 250 includes the second indicating data. In some implementations, the fourth station 40 is configured to determine that whether the bandwidth information indication sub-field 252 of the HT control field 250 includes the second indicating data (“01” in this example).

In some implementations, the fourth station 40 is configured to process the bandwidth information in the control frame 200 in response to determining that the second indicating data is in the HT control field 250. In some implementations, the fourth station 40 is configured to process information in the bandwidth information sub-field 254 in response to determining that the second indicating data (“01” in this example) is in the bandwidth information indication sub-field 252.

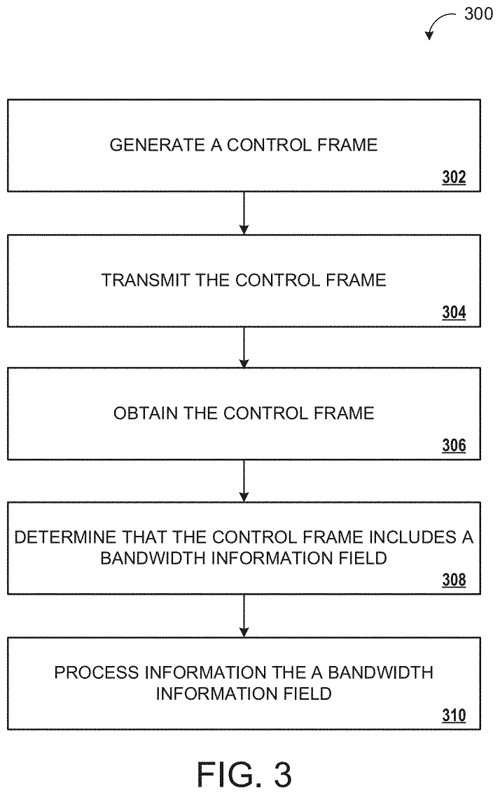

FIG. 3 is a flowchart of an example arrangement of operations for a method 300 of communicating the control frame 100. The method 300 may be performed by processing logic that may include hardware (circuitry, dedicated logic, etc.), software (such as is run on a general purpose computer system or a dedicated machine), or a combination of both, which processing logic may be included in any computer system or device. For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method 300, at operation 302, includes generating, at the first station 10, the control frame 100. As discussed above, the first station 10 is configured to generate the control frame 100 that includes the frame control field 110.

At operation 304, the method 300 includes transmitting the control frame 100 including indicating data (e.g., “0000” shown in FIG. 1) in the frame control field 110 via a wireless communication connection. As discussed above, the indicating data indicates that the control frame 100 includes a bandwidth information field 150.

At operation 306, the method 300 includes, at the second station 20, receiving or obtaining the control frame 100.

At operation 308, the method 300 includes, at the second station 20, determining that the control frame 100 includes the indicating data in a frame control field 110. As discussed above, the indicating data is configured or pre-assigned to indicate that the control frame 100 includes the bandwidth information field 150.

At operation 310, the method 300 includes, at the second station 20, when the indicating data is determined to be in the frame control field 110, processing bandwidth information in the bandwidth information field 150.

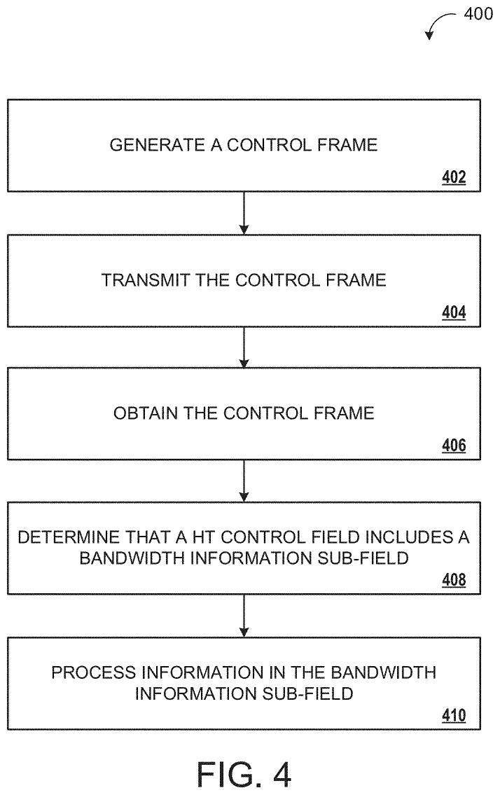

FIG. 4 is a flowchart of an example arrangement of operations for a method 400 of communicating the control frame 200. The method 400 may be performed by processing logic that may include hardware (circuitry, dedicated logic, etc.), software (such as is run on a general purpose computer system or a dedicated machine), or a combination of both, which processing logic may be included in any computer system or device. For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method 400, at operation 402, includes generating, at the third station 30, the control frame 200. As discussed above, the third station 30 is configured to generate the control frame 200 that includes the high throughput control field 250.

At operation 404, the method 400 includes transmitting, at the third station 30, the control frame 200 including indicating data (e.g., “01” shown in FIG. 2) in the high throughput control field 250 via a wireless communication connection. As discussed above, in some implementations, the indicating data indicates that the high throughput control field 250 includes a bandwidth information field 150. In some implementations, the indicating data indicates that the control frame 200 includes the bandwidth information.

At operation 406, the method 400 includes, at the fourth station 40, receiving or obtaining the control frame 200.

At operation 408, the method 400 includes, at the fourth station 40, determining that whether the high throughput field 250 includes indicating data. As discussed above, in some implementations, the indicating data is configured or pre-assigned to indicate that the high throughput control field 250 includes the bandwidth information sub-field 254. In some implementations, the indicating data is configured or pre-assigned to indicate that the control frame 200 includes the bandwidth information.

At operation 410, the method 400 includes, at the fourth station 40, when the indicating data is determined to be in the high throughput field 250, processing bandwidth information in the control frame 200 (e.g., bandwidth information sub-field 254 of the control frame 200).

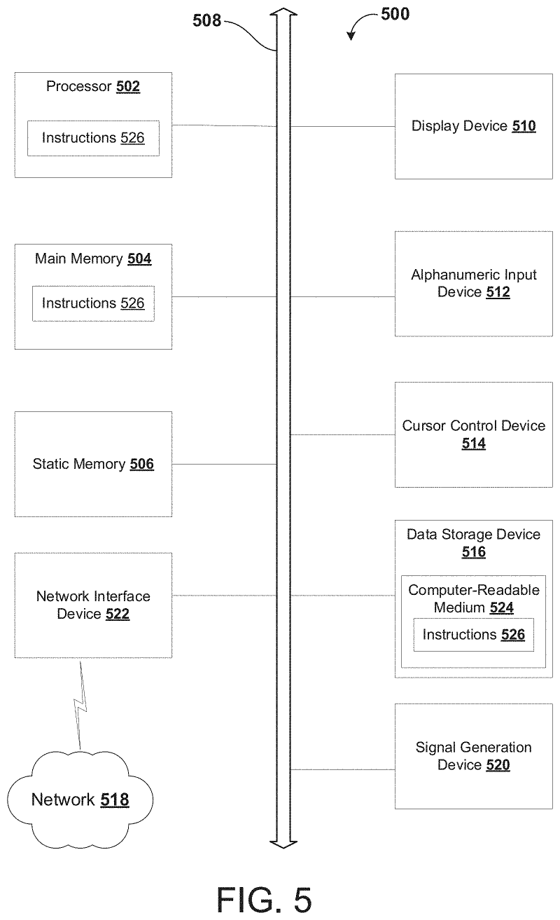

FIG. 5 is a schematic view illustrating a machine in the example form of a computing device 500 within which a set of instructions, for causing the machine to perform any one or more of the methods discussed herein, may be executed. The computing device 500 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The example computing device 500 includes a processing device (e.g., a processor) 502, a main memory 504 (e.g., read-only memory (ROM), flash memory, dynamic random access memory (DRAM) such as synchronous DRAM (SDRAM)), a static memory 506 (e.g., flash memory, static random access memory (SRAM)) and a data storage device 516, which communicate with each other via a bus 508.

Processing device 502 represents one or more general-purpose processing devices such as a microprocessor, central processing unit, or the like. More particularly, the processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also include one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computing device 500 may further include a network interface device 522 which may communicate with a network 518. The computing device 500 also may include a display device 510 (e.g., a liquid crystal display (LCD) or a cathode ray tube (CRT)), an alphanumeric input device 512 (e.g., a keyboard), a cursor control device 514 (e.g., a mouse) and a signal generation device 520 (e.g., a speaker). In at least one implementation, the display device 510, the alphanumeric input device 512, and the cursor control device 514 may be combined into a single component or device (e.g., an LCD touch screen).

The data storage device 516 may include a computer-readable storage medium 524 on which is stored one or more sets of instructions 526 embodying any one or more of the methods or functions described herein. The instructions 526 may also reside, completely or at least partially, within the main memory 504 and/or within the processing device 502 during execution thereof by the computing device 500, the main memory 504 and the processing device 502 also constituting computer-readable media. The instructions may further be transmitted or received over a network 518 via the network interface device 522.

While the computer-readable storage medium 526 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A system for wireless communication, the system comprising:
data processing hardware; and
memory hardware in communication with the data processing hardware, the memory hardware storing instructions that when executed on the data processing hardware cause the data processing hardware to perform operations comprising:
generate a control frame, the control frame including a frame control field, and
transmit the control frame including indicating data in the frame control field,
wherein the indicating data indicates that the control frame includes bandwidth information.

2. The system of claim 1, wherein the bandwidth information includes at least one from color data and transmission opportunity data.

3. The system of claim 1, wherein the bandwidth information includes preamble puncturing data.

4. The system of claim 3, wherein the preamble puncturing data includes dynamic preamble puncturing data.

5. The system of claim 1, wherein the bandwidth information includes data that support dynamic request to send (RTS)/clear to send (CTS) negotiation.

6. The system of claim 1, wherein the bandwidth information includes bandwidth information for any bandwidth value including 320 MHz or greater.

7. The system of claim 1, wherein the bandwidth information is included in the control frame instead of a high throughput control field.

8. The system of claim 1, wherein the control frame is in a non-high throughput duplicate format.

9. A system for wireless communication, the system comprising:
data processing hardware; and
memory hardware in communication with the data processing hardware, the memory hardware storing instructions that when executed on the data processing hardware cause the data processing hardware to perform operations comprising:
obtain a control frame,
determine that the control frame includes indicating data in a frame control field, the indicating data configured to indicate that the control frame includes bandwidth information,
when the indicating data is determined to be in the frame control field, processing the bandwidth information.

10. The system of claim 9, wherein the indicating data is provided in a subtype sub-field of the frame control field.

11. The system of claim 9, wherein the bandwidth information includes at least one from color data and transmission opportunity data.

12. The system of claim 9, wherein the bandwidth information includes preamble puncturing data.

13. The system of claim 12, wherein the preamble puncturing data includes dynamic preamble puncturing data.

14. The system of claim 9, wherein the bandwidth information includes data that support dynamic request to send (RTS)/clear to send (CTS) negotiation.

15. The system of claim 9, wherein the bandwidth information includes bandwidth information for any bandwidth value including 320 MHz or greater.

16. A system for wireless communication, the system comprising:
data processing hardware; and
memory hardware in communication with the data processing hardware, the memory hardware storing instructions that when executed on the data processing hardware cause the data processing hardware to perform operations comprising:
generate a control frame, the control frame including a high throughput control field, and
transmit the control frame including indicating data in the high throughput control field,
wherein the indicating data indicates that the high throughput control field or the control frame includes bandwidth information.

17. The system of claim 16, wherein the bandwidth information includes at least one from color data, preamble puncturing data, transmission opportunity data, and data that supports send (RTS)/clear to send (CTS) negotiation.

18. The system of claim 17, wherein the preamble puncturing data includes dynamic preamble puncturing data.

19. The system of claim 16, wherein the bandwidth information includes bandwidth information for any bandwidth value including 320 MHz or greater.

20. The system of claim 16, wherein the control frame is a control wrapper frame.
